(19) United States
(12) Patent Application Publication
(10) Pub. No.: US 2026/0061930 A1
(43) Pub. Date: Mar. 5, 2026

(54) METHOD FOR CONTROLLING THE HEADLIGHTS OF A MOTOR VEHICLE

(71) Applicant: HELLA GMBH & CO. KGAA, Lippstadt (DE)

(72) Inventors: Boris Kubitza, Möhnesee-Körbecke (DE); Carsten Wilks, Lippstadt (DE)

(21) Appl. No.: 19/312,918

(22) Filed: Aug. 28, 2025

(30) Foreign Application Priority Data
Aug. 29, 2024 (DE) 102024124673.1

(51) Int. Cl. B60Q 1/14; H05B 47/125

(52) U.S. Cl. CPC B60Q 1/143; H05B 47/125; B60Q 2300/054; B60Q 2300/3321

(57) ABSTRACT

A method for controlling headlights of a motor vehicle, including capturing of environment data of a surroundings of the motor vehicle using sensors of the motor vehicle, wherein the surroundings comprise a road on which the motor vehicle is traveling, detection using the environment data to determine whether street lighting system independent of the motor vehicle is present, detection using the environment data to determine whether there are trees next to the road, and setting of a brightness of the headlights using the results of the detections.

### CROSS-REFERENCE TO RELATED APPLICATIONS

The present application claims the benefit of German Patent Application No. 10-2024-124-673.1, filed Aug. 29, 2024, the disclosure of which is incorporated by reference.

### FIELD OF THE INVENTION

The present invention relates to a method for controlling headlights of a motor vehicle.

### BACKGROUND OF THE INVENTION

It is known from the prior art to adapt the brightness of the light emitted by the headlights to the surroundings of the motor vehicle. Thus, WO2023/133431A1 discloses an autonomous vehicle with environment detection via sensors. Areas that do not reach a desired light intensity threshold value are illuminated more strongly than areas that reach this light intensity threshold value.

### SUMMARY OF THE INVENTION

In contrast, the object of the present invention is to increase road traffic safety. This object is achieved by a method, a control unit, and a motor vehicle. Embodiments of the invention are also set forth herein.

According to the current embodiments, environment data of a surroundings of the motor vehicle is recorded using sensors of the motor vehicle. The surroundings in this case comprise a road on which the motor vehicle is traveling. Using the environment data, it is detected whether a street lighting system independent of the motor vehicle is present. The street lighting system can in this case illuminate at least sections of the road. It also uses the environment data to detect whether there are trees present next to the road. A brightness of the headlights is adjusted using results of the detections.

The results can be, for example, that trees are present or that no trees are present, and that the street lighting system is present or that no street lighting system is present.

The use of the results is particularly advantageous in an inner city area. Without trees, streets in inner city areas are usually very well lit by street lighting system. However, this illumination can be impaired by trees. It is therefore advantageous to adjust the brightness of the headlights depending on whether a street lighting system and trees are present.

According to one embodiment of the invention, the street lighting system can comprise street lamps.

According to one embodiment of the invention, the sensors can comprise at least one camera.

According to one embodiment of the invention, the brightness of the headlights can be set to a first value if it has been detected that the street lighting system is present and that there are no trees next to the road. The brightness of the headlights can be set to a second value if it has been detected that the street lighting system is present and that there are trees next to the road. In this case, the second value can be higher than the first value. In particular, this can mean that the headlights are brighter when the brightness is set to the second value than when the headlights are set to the first value. It should be noted that the first value and the second value are each considered as a total value for brightness in the context of this description. It is possible in this case that one of the headlights has a different brightness than the other headlight if the brightness was set to the first value. The same applies to the second value.

This brightness setting is particularly advantageous as the brightness is reliably increased when trees could impair the illumination of the road. This ensures both good visibility of the motor vehicle and good illumination of the road, so that the driver of the motor vehicle can easily recognize any hazards. Compared to prior art methods, this is advantageous in the case where trees are present, as areas that are too dark cannot even appear once the trees have been detected.

In addition, the brightness is reduced if sufficient illumination of the road is ensured by the street lighting system, for example if there are no trees. This reduces energy consumption and the risk of dazzling other road users or the driver of the motor vehicle.

According to one embodiment of the invention, a measured value can be determined using the environment data. The measured value can comprise information about the extent to which the trees affect the illumination of the road by the street lighting system. It is possible that the brightness is only set to the second value if the measured value is higher than a threshold value.

The measured value can be determined, for example, by determining the parameters of the trees from which the measured value is determined. The parameters can include, for example, the size of the trees and/or the distance of the trees from the streetlights.

This embodiment of the invention is particularly advantageous so that the brightness is not unnecessarily increased for relatively few small trees. By selecting a suitable threshold value, it can be set how many trees must be present and/or how large the trees must be for the brightness to be increased.

According to one embodiment of the invention, the measured value and the threshold value can each be a percentage value. The measured value can indicate a portion of the road whose illumination by the street lighting system is impaired by the trees. In particular, this can also include determining the measured value indirectly, for example, by determining the proportion of the road whose illumination by the street lighting system is not impaired by the trees.

The control unit according to the current embodiments is designed to carry out a method according to one embodiment of the invention.

The motor vehicle according to the current embodiments comprises a control unit according to one embodiment of the invention, the headlights, and the sensors.

Further features and advantages of the present invention will become apparent from the following description of preferred embodiments with reference to the accompanying figures. The same reference symbols are used for identical or similar components, features, or elements and for components, features, or elements with identical or similar functions.

### BRIEF DESCRIPTION OF THE DRAWING

In the FIGURE:

FIG. 1 is a schematic representation of a method according to one embodiment of the invention.

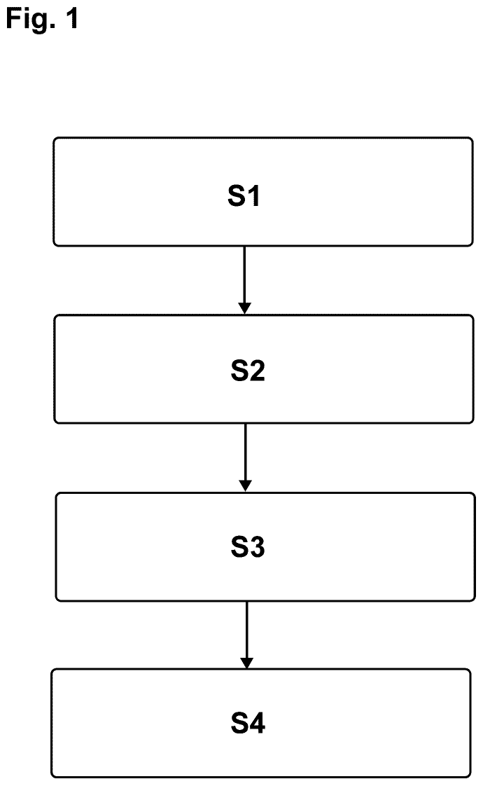

### DETAILED DESCRIPTION OF THE CURRENT EMBODIMENT

In step S1, environment data of a surroundings of the motor vehicle is recorded using sensors of the motor vehicle. The surroundings comprise a road on which the motor vehicle is traveling. The surroundings also comprise areas next to the road where street lamps and/or trees may be located. The environment data can preferably be image and/or video data recorded by a camera.

Using the environment data, step S2 detects whether street lighting system is present that is independent of the motor vehicle. These can be street lamps, for example. Street lamps are often present in inner city areas.

In step S3, the system uses the environment data to detect whether there are trees next to the road. Under certain circumstances, these trees can obstruct the illumination of the road if they are sufficiently large and/or sufficiently close to the street lamps.

The brightness of the motor vehicle's headlights is adjusted in step S4 using the results of the detections from steps S2 and S3. For example, if it is detected that the street lighting system is present and there are no trees, the brightness of the headlights is set to a first value. If it is detected that the street lighting system is present and trees are also present, the brightness of the headlights is set to a second value.

The first value is lower than the second value. The headlights are therefore set to a higher brightness when the street lighting system and trees are present than when the street lighting system is present and there are no trees.

This is particularly advantageous in inner city areas, where under certain circumstances the illumination of the road by the existing street lighting system may be impaired by trees. In this case, safety can be increased by setting the brightness of the headlights to the second value. Energy can be saved, however, if there are no trees and the road is therefore is illuminated by the street lighting system without obstruction, by setting the brightness of the headlights to the first value. This also reduces the likelihood of dazzling other road users and the driver of the motor vehicle.

If there is no street lighting system, it is irrelevant whether there are trees next to the road. In this case, the headlights can be controlled as known from the prior art.

### LIST OF REFERENCE NUMBERS

S1 capturing
S2 detection
S3 detection
S4 setting

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for controlling headlights of a motor vehicle, comprising:
capturing environment data of a surroundings of the motor vehicle using sensors of the motor vehicle, wherein the surroundings comprise a road on which the motor vehicle is traveling;
detecting, using the environment data, whether a street lighting system independent of the motor vehicle is present;
detecting, using the environment data, whether there are trees next to the road; and
setting a brightness of the headlights based on whether a street lighting system independent of the motor vehicle is present and whether there are trees next to the road.

2. The method according to claim 1, wherein the street lighting system comprises street lamps.

3. The method according to claim 1, wherein the sensors comprise at least one camera.

4. The method according to claim 1, wherein the brightness of the headlights is set to a first value if it is detected that a street lighting system independent of the motor vehicle is present and that there are no trees next to the road, wherein the brightness of the headlights is set to a second value if it is detected that a street lighting system independent of the motor vehicle is present and that there are trees next to the road, and wherein the second value is higher than the first value.

5. The method according to claim 4, wherein a measured value is determined using the environment data, wherein the measured value comprises information about how much the trees affect illumination of the road by the street lighting system, and wherein the brightness is set to the second value if the measured value is higher than a threshold value.

6. The method according to claim 5, wherein the measured value and the threshold value are percentage values, and wherein the measured value indicates a portion of the road whose illumination by the street lighting system is affected by the trees.

7. A control unit for controlling headlights of a motor vehicle, wherein the control unit is configured to carry out a method comprising:
capturing environment data of a surroundings of the motor vehicle using sensors of the motor vehicle, wherein the surroundings comprise a road on which the motor vehicle is traveling;
detecting, using the environment data, whether a street lighting system independent of the motor vehicle is present;
detecting, using the environment data, whether there are trees next to the road; and
setting a brightness of the headlights based on whether a street lighting system independent of the motor vehicle is present and whether there are trees next to the road.

8. A motor vehicle comprising:
headlights;
sensors; and
a control unit configured to control the headlights, wherein the control unit is configured to:
capture environment data of a surroundings of the motor vehicle using the sensors, wherein the surroundings comprise a road on which the motor vehicle is traveling;
detect, using the environment data, whether a street lighting system independent of the motor vehicle is present;
detect, using the environment data, whether there are trees next to the road; and
set a brightness of the headlights based on whether a street lighting system independent of the motor vehicle is present and whether there are trees next to the road.
